(19) United States
(12) Patent Application Publication
(10) Pub. No.: US 2014/0179139 A1
(43) Pub. Date: Jun. 26, 2014

(54) CONNECTOR FOR LED MODULE BOARD

(71) Applicant: SMK Corporation, Tokyo (JP)

(72) Inventors: Katsuyoshi Tanaka, Toyama-shi (JP); Toshimitsu Takeda, Toyama-shi (JP)

(21) Appl. No.: 13/939,783

(22) Filed: Jul. 11, 2013

(30) Foreign Application Priority Data
Dec. 26, 2012 (JP) JP 2012-282309

(51) Int. Cl. H01R 13/717

(52) U.S. Cl. CPC H01R 13/7175
USPC 439/226

(57) ABSTRACT

There is provided a connector for an LED module board excellent in assembly, heat dissipation and insulation. The connector for an LED module board for holding and electrically connecting the LED module board includes: a lower cover member on which the LED module board is placed; and an upper cover member having a connection terminal brought into elastic contact with a power supply pad included in the LED module board, wherein at least a portion of the lower cover member at a position of a bottom face of the LED module board is made of a thermally-conductive and insulating material, the upper cover member is structured so that light emitted from the LED module board is directed outward, and the upper cover member is engaged with the lower cover member in a state in which the LED module board is placed on the lower cover member.

### CROSS-REFERENCE TO RELATED APPLICATIONS

This application claims priority under 35 USC §119(a) to Japanese Patent Application No. JP 2012-282309, filed on Dec. 26, 2012, the entire contents of which is incorporated herein by reference.

### BACKGROUND

1. Technical Field

The present invention relates to a connector used for electrical connection of chip-on-board LED modules.

2. Description of the Related Art

Chip-on-board (COB) LED modules are boards on which LED devices are mounted to and have been employed in the field of lighting and the like. COB LED modules need to dissipate heat generated by LED devices (e.g., to its surrounding environment).

Accordingly, in the related art and referring to FIG. 10A-10D collectively, an LED module board 2 is placed on a heat sink 3 for heat dissipation. A cover member 110 having a connection terminal for power supply is fixed onto the LED module board 2 and the heat sink 3 by fastening members 4a, 4b such as screws in a manner that the cover member 110 is pressed onto the heat sink. Further, cable lines 5, 5 are connected to contacts provided on the cover member, as shown in FIGS. 10(a) and 10(b), for example.

With such a method for mounting an LED module board, however, the LED module board and the cover member that is a connector needs to be attached individually with the heat sink, which makes the assembly work troublesome.

Furthermore, as shown in FIG. 10(c), there is a problem that the contact force of a connection terminal 116a for power supply to a power supply pad provided on the LED module board varies with the tightening force of the fastening members 4a, 4b and is thus unstable.

As shown in FIG. 10(d), there is further a problem that the spatial creepage distance L₀ from a contact of the connection terminal 116a to the heat sink 3 is short, which results in easy leakage.

For example, JP 2012-164613 A discloses an LED connector allowing daisy chain connection of LED modules. The connector disclosed in this literature, however, is also used in a manner that an LED module board and the connector are attached onto a heat sink individually.

In addition, JP 2012-109405 A discloses a technique for attaching an LED package to a heat sink with a thermally conductive and electrically insulating material therebetween. Lighting equipment disclosed in the literature, however, does not include a connector (cover member) for an LED module board.

### SUMMARY

### Technical Problem

An object of the present invention is to provide a connector for an LED module board excellent in assembly, heat dissipation, and insulation.

### Solution to Problem

A connector for an LED module board according to the present invention is a connector for holding and electrically connecting the LED module board, and includes: a lower cover member on which the LED module board is placed; and an upper cover member having a connection terminal brought into elastic contact with a power supply pad included in the LED module board, wherein at least a portion of the lower cover member at a position of a bottom face of the LED module board is made of a thermally-conductive and insulating material, the upper cover member is structured so that light emitted from the LED module board is directed outward, and the upper cover member is engaged with the lower cover member in a state in which the LED module board is placed on the lower cover member.

The lower cover member refers to a member for holding the LED module board from the rear face thereof, and the upper cover member refers to a member that is to be placed on the surface of the LED module board on which LED devices are mounted and a power supply pad is provided and that has a connection terminal for power supply brought into elastic contact with the power supply pad.

In the present invention, the lower cover member may be formed of a thermally-conductive and insulating material and have an opening at a portion where the bottom face of the LED module board is positioned, and a thermally-conductive insulating sheet is provided over the opening.

Furthermore, the connection terminal for power supply provided on the upper cover member can be brought into elastic contact with the power supply pad of the LED module board by an engaging force engaging the upper cover member with the lower cover member.

### Advantageous Effects of Invention

Since a connector according to the present invention allows sub-assembly of an LED module board with a lower cover member and an upper cover member in advance, the LED module board can be attached to a heat sink in a state in which the LED module board is held by the connector, which is excellent in assembly.

Furthermore, since a connection terminal for power supply is brought into contact with a power supply pad of the LED module by a predetermined contact force when the lower cover member and the upper cover member are engaged with each other, the connector is excellent in stability of electrical connection.

Since the lower cover member has high thermal conductivity and insulation, the spatial creepage distance can be made longer by the lower cover member than that in the case of the related art where an LED module board is directly attached to a heat sink.

### BRIEF DESCRIPTION OF THE DRAWINGS

FIG. 1(a) shows a state in which an LED module board is placed on a lower cover member;

FIG. 1(b) shows a state of sub-assembly in which an upper cover member is engaged with the lower cover member;

FIGS. 2(a) to 2(c) show procedures for assembling a connector;

FIG. 3(a) shows a state before attaching the connector to a heat sink;

FIG. 3(b) shows a state after attaching the connector to the heat sink;

FIG. 4(a) shows a contact part in a bottom view of the upper cover member;

FIG. 4(b) shows a relation between a rear face of the upper cover member and the lower cover member;

FIGS. 5(a) to 5(c) show sectional views of procedures for attaching the LED module board to the connector;

FIG. 5(d) shows a spatial creepage distance of the contact part;

FIG. 6(a) shows an example in which an opening is provided in the lower cover member and a thermally-conductive insulating sheet is provided over the opening;

FIG. 6(b) shows an assembly state thereof;

FIGS. 7(a) to 7(d) show cross sectional views of assembly according to a second embodiment of the present disclosure;

FIG. 7(e) shows an enlarged view of a contact part;

FIG. 8 shows an example in which a thermally-conductive insulating sheet is provided over an opening in a lower cover member on the rear face of the lower cover member;

FIGS. 9(a) and 9(b) show other exemplary structures of connection terminals;

FIGS. 10(a) and 10(b) show an example of assembly according to the related art; and

FIGS. 10(c) and 10(d) show a contact structure according to the related art.

### DESCRIPTION OF THE VARIOUS EMBODIMENTS

An exemplary structure of a connector for an LED module board (hereinafter, simply referred to as a connector) 1 according to the present invention will be described with reference to the drawings.

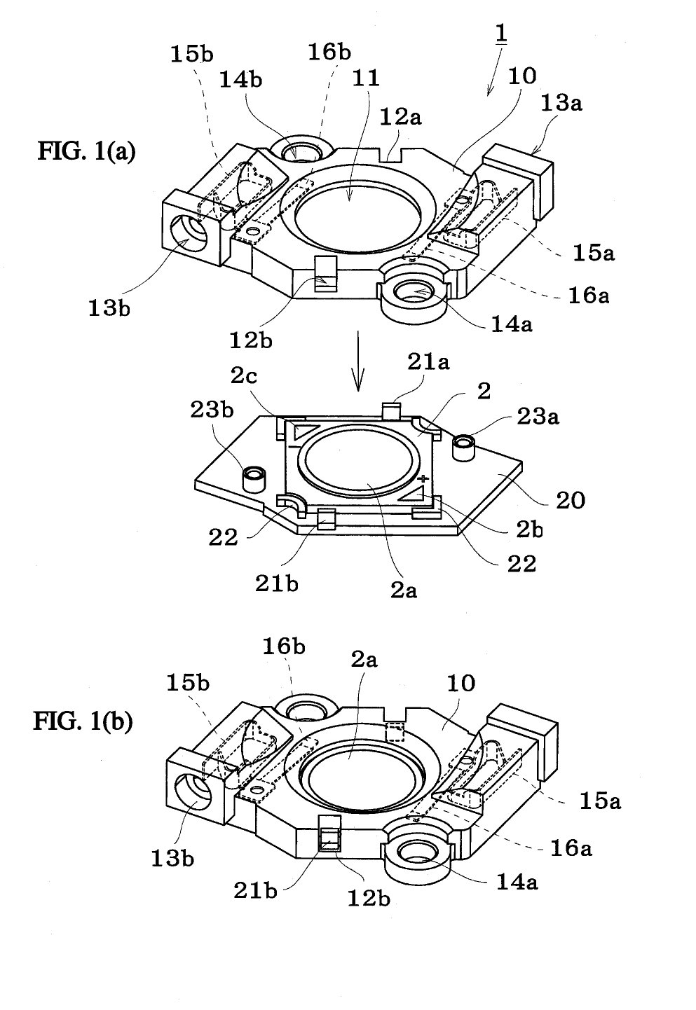

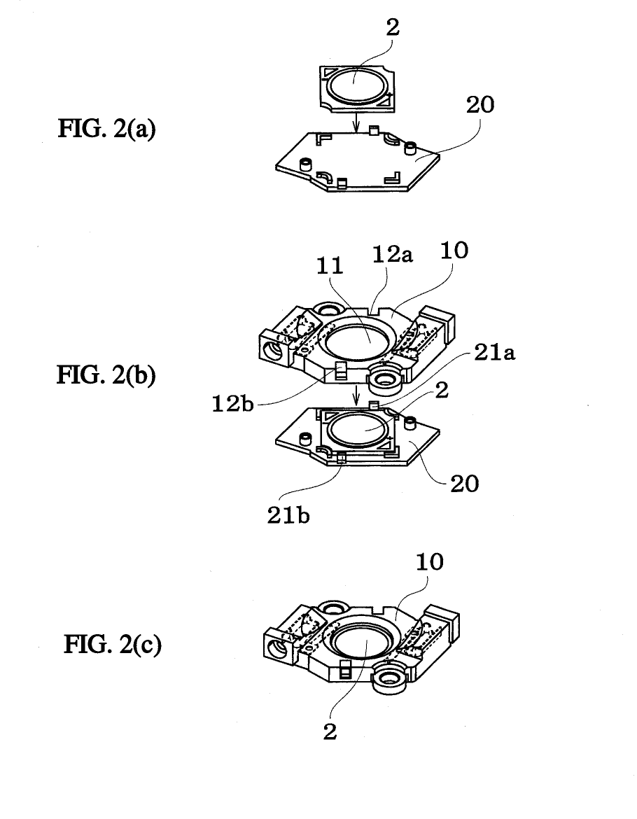

FIGS. 1(a) and 1(b) show a first embodiment of the present disclosure, and FIGS. 2(a) to 2(c) show exemplary procedures for assembly.

A lower cover member 20 is formed of a thermally conductive and insulating resin material with a thermal conductivity (by steady state method) of 1.5 W/mK or higher, or preferably 5.0 W/mK or higher, and a dielectric breakdown voltage of 1 KV or higher as a raw material.

The lower cover member 20 has an upper face (a face on which the LED module board is placed) with a flat central part so that the rear face of the LED module board 2 is brought into close contact therewith.

The lower cover member 20 also has positioning members 22 such as projections and ribs where necessary so that the LED module board 2 can be easily positioned at a predetermined position when the LED module board 2 is placed on the lower cover member 20.

The lower cover member 20 is provided with claw-like locking portions 21a, 21b for engaging an upper cover member 10 as will be described later.

The LED module board 2 is placed on the upper face of the lower cover member 20.

The shape of this LED module board is not limited. The LED module board has thereon a light emitting part 2a on which LED devices are mounted and power supply pads 2b, 2c for power supply that are connected by patterning.

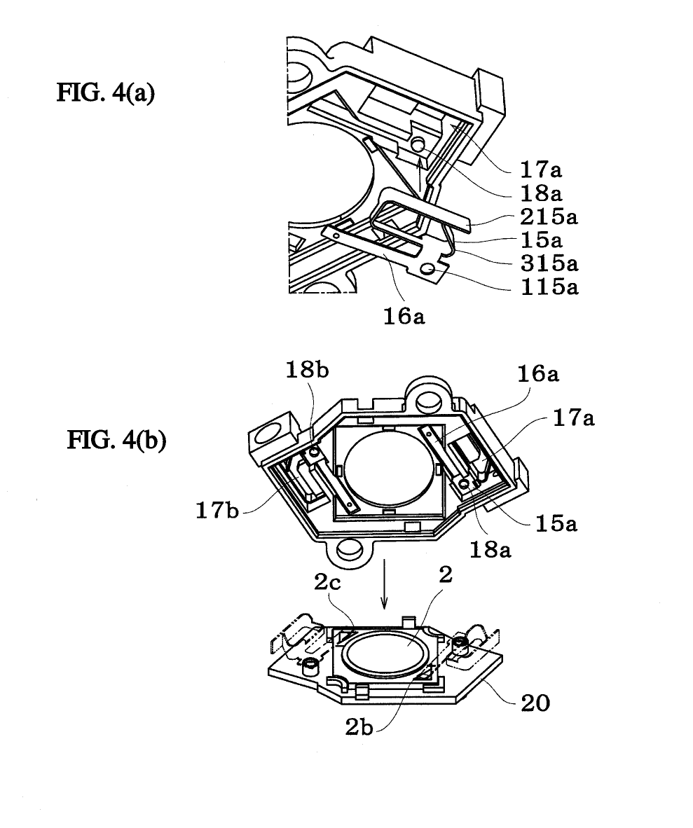

The upper cover member 10 is a resin molding. In the present embodiment, the upper cover member 10 has an opening 11 substantially in the shape of a circular hole in which the light emitting part 2a is positioned, and contacts 15a, 15b formed integrally with connection terminals 16a, 16b for power supply that are attached to accommodating recesses 17a, 17b by bosses 18a, 18b as shown in FIGS. 4(a) and 4(b).

The contacts 15a, 15b each have elastic metal strips 215a, 315a opposed to each other in this embodiment, and cable lines (wires) are inserted for connection between this pair of elastic metal strips 215a, 315a via cable connection holes 13a, 13b of the upper cover member 10.

The contacts 15a, 15b each have a fixed hole 115a for attachment using the bosses 18a, 18b of the upper cover member 10 and are supported by supporting portions 23a, 23b standing upright on the lower cover member 20 from the lower surface thereof.

Means by which the contacts 15a, 15b are attached to the upper cover member 10 is not limited. In the present embodiment, the contacts 15a, 15b are subjected to thermal caulking by using the bosses 18a, 18b.

The connection terminals may be coupled to cable lines by insulation displacement connector terminals or crimped terminals in advance as shown in FIGS. 9(a) and 9(b).

The upper cover member 10 has locked portions 12a, 12b having a hole shape to be engaged with the claw-like locking portions 21a, 21b provided on the lower cover member 20.

The hole shape of the locked portions 12a, 12b allows the locked portions 12a, 12b and the claw-like locking portions 21a, 21b to be positioned relative to each other only by inserting the locking portions 21a, 21b, which results in a stable elastic engaging force.

The claw-like portions may be provided on either of the upper cover member 10 and the lower cover member 20 as long as the members can be engaged with each other, and the shape of the locked portions is not limited to a hole shape.

The upper cover member 10 also has mounting holes 14a, 14b for fixing the upper cover member 10 to the heat sink 3 in a state in which the LED module board is placed on the lower cover member 20 and sub-assembled in engagement therewith.

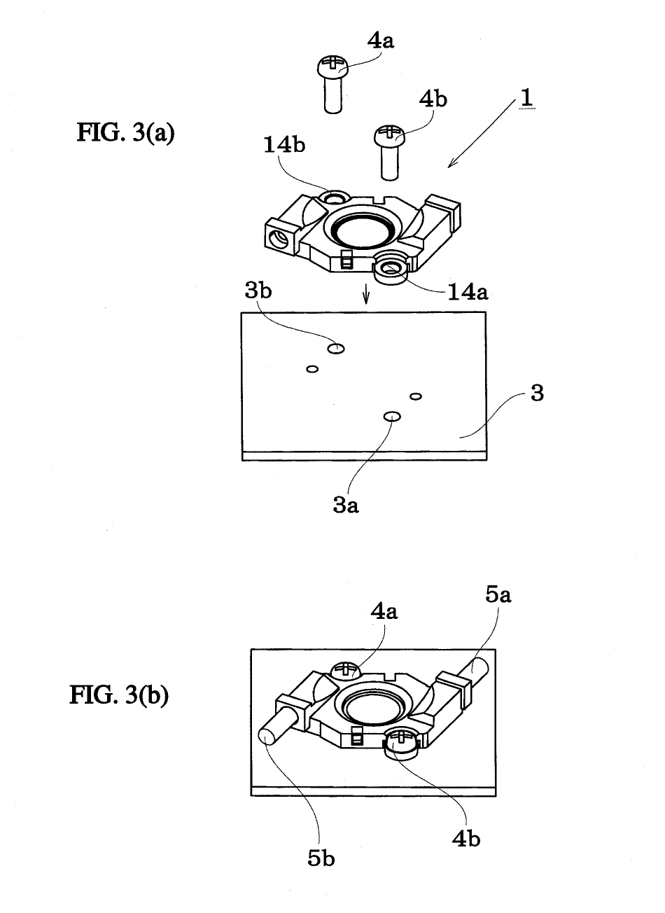

The connector 1 in the sub-assembled state is fixed to the heat sink 3 made of a heat dissipating material such as an aluminum plate as shown in FIGS. 3(a) and 3(b).

In the present embodiment, fastening members 4a, 4b such as screws are inserted into the mounting holes 14a, 14b of the upper cover member 10 and tightened and fixed into tapped holes 3a, 3b provided in the heat sink 3.

After the connector 1 is fixed to the heat sink 3, the cable lines 5a, 5b are inserted into the cable connection holes 13a, 13b of the upper cover member 10 and electrically connected to the contacts 15a, 15b.

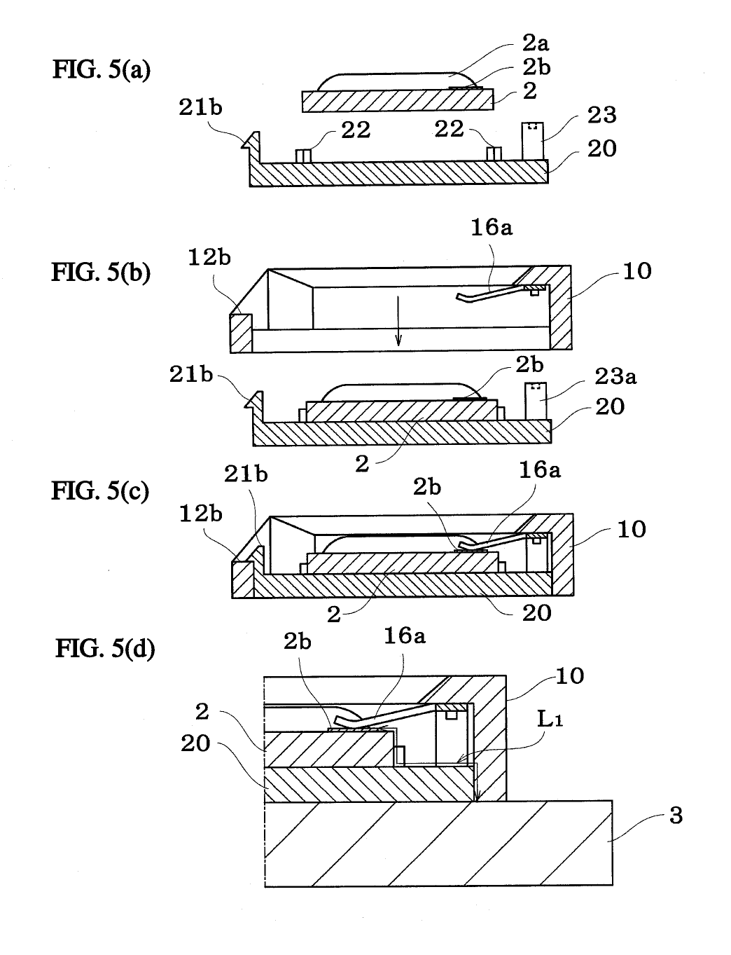

FIGS. 5(a) to 5(d) show procedures for assembly of the connector and the vicinity of the contact part in sectional views.

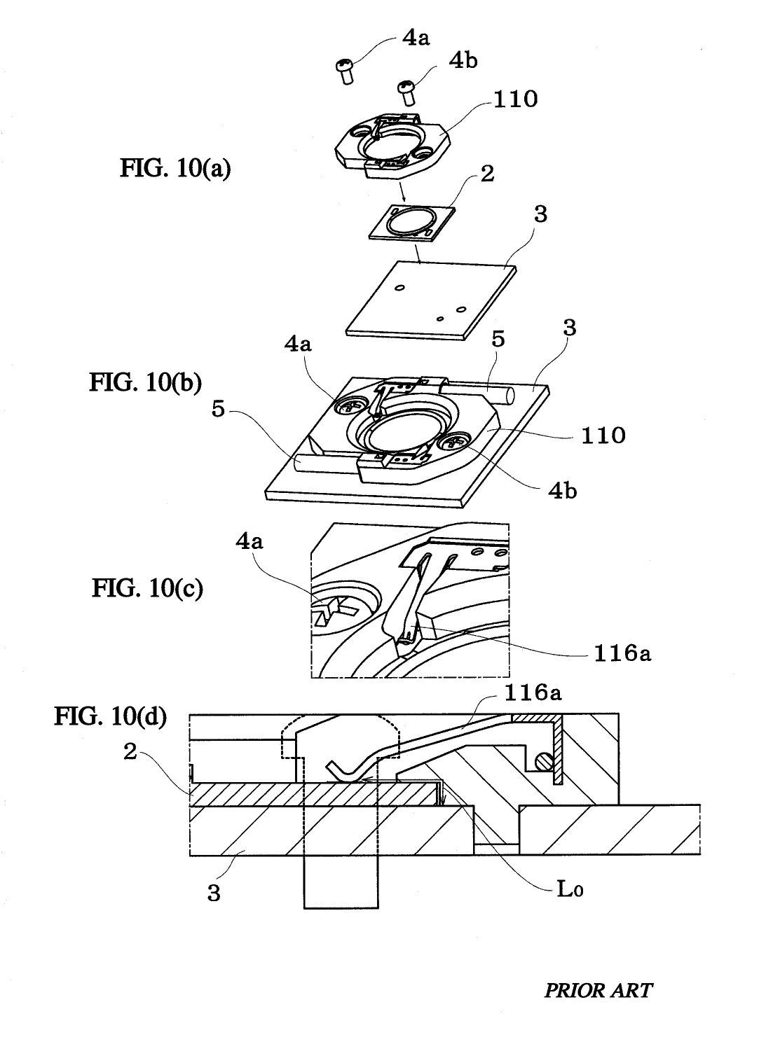

As shown in FIG. 5(d), the connection terminal 16a for power supply is brought in elastic contact with the power supply pad 2b of the LED module board 2 by the engaging force engaging the upper cover member 10 with the lower cover member 20, and the spatial creepage distance L₁ from the contact part to the heat sink 3 is longer than that of the structure of the related art shown in FIG. 10(d) by the portion of the lower cover member 20.

As a result, resistance to leakage is improved.

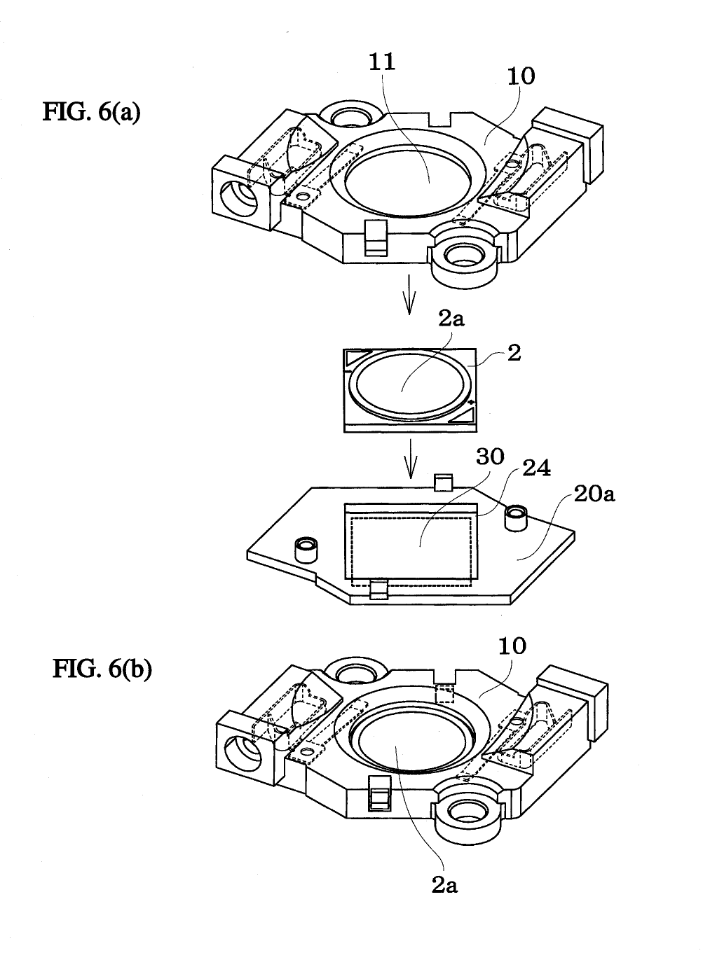

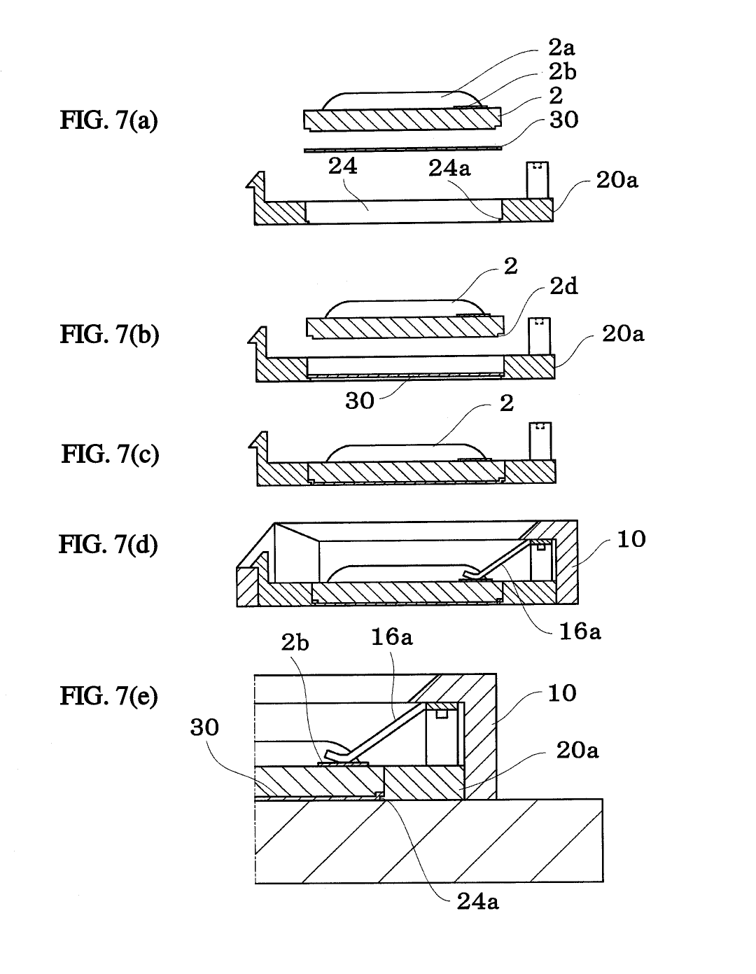

FIGS. 6(a), 6(b), and 7(a) to 7(e) show a second embodiment of the present disclosure.

In the present embodiment, an opening 24 for allowing the LED module board 2 to be inserted into a lower cover member 20a is formed and a thermally-conductive insulating sheet 30 is provided to seal the opening as shown in FIG. 7(a).

A stepped portion 24a is formed at the inner circumference of the opening 24 so as to facilitate arrangement of the sheet.

In addition, a stepped portion 2d to be fitted thereto is formed in the rear face of the LED module board 2.

When the LED module board 2 is placed on the lower cover member 20a having such a structure, the upper cover member 10 and the lower cover member 20 are sub-assembled in such a manner that the rear face of the LED module board 2 is brought into close contact with the thermally-conductive insulating sheet 30 as shown in FIGS. 7(b) and 7(c).

FIG. 7(e) shows a state in which the connector is attached to the heat sink 3, which is an assembled structure with high heat dissipation.

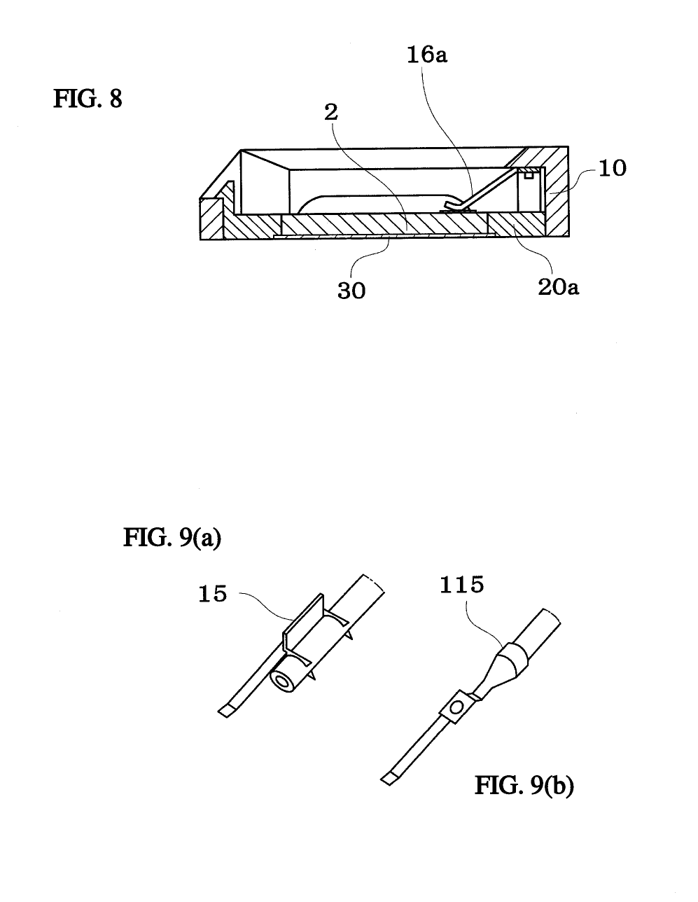

The method for arranging the thermally-conductive insulating sheet 30 over the opening 24 formed in the lower cover member 20a is not limited to that sealing the opening 24 from the surface (the face on the side of the upper cover member) of the lower cover member 20a as illustrated in FIGS. 7(a) to 7(e), but the sheet may be attached to seal the opening 24 on the rear face of the lower cover member 20a as shown in FIG. 8.

Attachment of the thermally-conductive insulating sheet 30 on the rear face of the lower cover member 20a in this manner allows the LED module board 2 to be held by the thermally-conductive insulating sheet 30 in the sub-assembly.

What is claimed is:

1. A connector for an LED module board for holding and electrically connecting the LED module board, the connector comprising:
a lower cover member on which the LED module board is placed; and
an upper cover member having a connection terminal for power supply brought into elastic contact with a power supply pad included in the LED module board,
wherein, at least a portion of the lower cover member at a position of a bottom face of the LED module board is made of a thermally-conductive and insulating material,
wherein, the upper cover member is structured so that light emitted from the LED module board is directed outward, and
wherein, the upper cover member is engaged with the lower cover member in a state in which the LED module board is placed on the lower cover member.

2. The connector for an LED module board according to claim 1, wherein the lower cover member is formed of a thermally-conductive and insulating material.

3. The connector for an LED module board according to claim 1, wherein the lower cover member has an opening at a portion where the bottom face of the LED module board is positioned and a thermally-conductive insulating sheet is provided over the opening.

4. The connector for an LED module board according to claim 1, wherein the connection terminal for power supply provided on the upper cover member is brought into elastic contact with the power supply pad of the LED module board by an engaging force engaging the upper cover member with the lower cover member.

5. The connector for an LED module board according to claim 2, wherein the connection terminal for power supply provided on the upper cover member is brought into elastic contact with the power supply pad of the LED module board by an engaging force engaging the upper cover member with the lower cover member.

6. The connector for an LED module board according to claim 3, wherein the connection terminal for power supply provided on the upper cover member is brought into elastic contact with the power supply pad of the LED module board by an engaging force engaging the upper cover member with the lower cover member.
